(19) United States
(12) Patent Application Publication
(10) Pub. No.: US 2018/0320855 A1
(43) Pub. Date: Nov. 8, 2018

(54) REDNECK POLE LIGHT

(71) Applicants: DONALD L. MORGAN, CANTON, MO (US); BOBBIE J. MORGAN, CANTON, MO (US)

(72) Inventors: DONALD L. MORGAN, CANTON, MO (US); BOBBIE J. MORGAN, CANTON, MO (US)

(21) Appl. No.: 15/970,655

(22) Filed: May 3, 2018

Related U.S. Application Data
(60) Provisional application No. 62/500,712, filed on May 3, 2017.

(51) Int. Cl. F21V 3/02; F21V 21/08; F21L 14/02; F21V 17/04; F21V 31/00

(52) U.S. Cl. CPC F21V 3/02; F21V 21/08; F21W 2131/10; F21V 17/04; F21V 31/005; F21L 14/02

(57) ABSTRACT

A redneck pole light has a decorative cylindrical bucket, a lid removably connection to the bucket, a ceramic light socket, a light source such as a 100 watt light bulb, a light fixture rated for 110 volt outdoor usage, a length of electrical cable, a portable support pole, and a hook. A user inserts the support pole into a ground surface and the pole thus the electrical cable for delivery of power to the bucket suspended from the pole upon the hook. A lid connects to the bucket where the lid has the socket upon it and the light source positioned inside the bucket. The cylindrical bucket has a handle that has its S shaped hook secured to the handle for ease of hanging the invention upon the pole. The invention casts a light upon an area through its translucent construction.

### CROSS-REFERENCE TO RELATED APPLICATION

This non-provisional application claims priority to pending provisional application No. 62/500,712 filed on May 3, 2017, all of which are owned by the same inventors.

### BACKGROUND OF THE INVENTION

The redneck pole light generally relates to lighting and more specifically to a light within a translucent container that stores its power cord therein.

From ancient times, people dislike the dark and seek to dispel it with illumination. Early man used flints, quartz, and like stones to create sparks. Early man then developed various friction methods to cause combustion such as bow drills. These methods provided fire and its light to people whether in groups or as individuals. Many times, such fires became known as campfires for their location near a campsite.

In time, man and industry developed flint and steel then matches for ignition of fires. In more recent times, industry has developed lighting from gas lamps of yore to modern electrified lighting systems. These various lighting system still seek to dispel the dark, a continuing struggle form ancient times.

Outdoor lighting may be necessary for those people, pets, and livestock spending time at a campsite, in a backyard, or at other locations during nighttime hours of a given day. Without proper illumination, people and objects may be subject to theft, injury, collision, becoming lost, and the like. It may be difficult to enjoy the outdoors at night without proper illumination. Further mosquitoes and other annoying insects may intrude upon a campsite, patio, or backyard area, making themselves a nuisance to people.

### DESCRIPTION OF THE PRIOR ART

Outdoor light refers to the use of outdoor illumination of private gardens, yards, lawns, and public landscapes and parks. It also refers to the enhancement and purposes of safety, nighttime aesthetics, accessibility, security, recreation and sports, social functions, and event uses.

The prior art has included various lanterns with internal power sources and lighting on cables with exposes bulbs. In time, the lanterns lose their power and go dim. In time, exposed bulbs suffer damage and break. With these weaknesses of the prior art and the age old quest to dispel the dark, a suitable solution is desired.

### SUMMARY OF THE INVENTION

The present invention of the redneck pole light provides its users with uniquely design outdoor lighting in locations where no security lights, yard lights, or other lighting becomes impractical or inadequate. The present invention features a ceramic light socket and a 100 watt light bulb installed within a plastic, or polymer, translucent bucket unit. These components work in conjunction to ensure bright illumination in an outdoor area. The present invention allows campers, anglers, hikers, backyard users, and other persons to install an exterior light with ease and convenience. The present invention functions effectively with minimal attraction of insects thus keeping a campsite or other area clean of the bugs and comfortable to people. The present invention eliminated the need for complicated outdoor light setups, extensive battery power, and other inconveniences associated with outdoor lighting.

Generally, the redneck pole light has a light source, a socket receiving the light source, a cable delivering electrical power to the socket, a container with a lid and a handle, and alternatively, a pole. The container has a generally hollow cylindrical form with a closed bottom. Opposite the bottom, the container has its lid that a user lid removes from the container as needed. The lid has the socket connected to it and the light source positioned on the lid so that the light source fits into the container when a user places the lid upon it. After usage of the invention, a user removes the lid, coils the cable within the container upon the bottom, and places the lid back upon the container, thus containing the invention. The light source includes an incandescent bulb over 40 watts, a light emitting diode, a fluorescent tube, and the like.

There has thus been outlined, rather broadly, the more important features of the invention in order that the detailed description thereof that follows may be better understood and that the present contribution to the art may be better appreciated. The present invention also includes a handle upon the container upwardly from the bottom and beneath the lid, a grip upon the handle, and a hook upon the grip extending outward from the handle. Additional features of the invention will be described hereinafter and which will form the subject matter of the claims attached.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

One object of the present invention is to provide a redneck pole light that illuminates an area beneath it.

Another object is to provide such a redneck pole light that does not attract insect.

Another object is to provide such a redneck pole light that is waterproof.

Another object is to provide such a redneck pole light that is capable of manufacturing and distribution at a price suitable for the users, customers, supply houses, retailers, distributors, and catalogs.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In referring to the drawings,

FIG. 1 is a perspective view of the invention showing its environment;

FIG. 2 is a perspective view of the invention;

FIG. 3 is a front view of the invention;

FIG. 4 is an alternate perspective view of the invention showing its environment;

FIG. 5 is an alternate perspective view of the invention showing its environment; and,

FIG. 6 is an exploded view.

The same reference numerals refer to the same parts throughout the various figures.

### DESCRIPTION OF THE PREFERRED EMBODIMENT

The present invention overcomes the prior art limitations by providing a redneck pole light. Referring now to FIGS. 1-5, the Redneck Pole Light is a decorative bucket light used to create ample outdoor lighting where none currently exists. The device is comprised of a plastic bucket, ceramic light socket, a 100 W light bulb, a 110V outdoor rated light fixture, a portable support pole, and a hook. The support pole is inserted into the ground by a user and supports a power cord, or cable, mounted to the bucket. A lid connects to the bucket with the bulb positioning inside the bucket. The plastic bucket has a handle that has an S shaped hook secured to it for ease of hanging the invention upon a pole.

A user can install the support pole, hang the bucket, and ensure the fixture is plugged into an electrical outlet via extension cord or a standard electrical cord. The light in the bucket allows the invention to brightly illuminate an outdoor area without attracting insects. Multiple inventions can be installed in a single area for additional lamination if necessary.

The present invention of the Redneck Pole Light can be constructed using a 1.5, 2.5, or 3.5 gallon plastic bucket with a lid and a handle. In an alternate embodiment, the bucket receives a decorative logo, lettering, or symbol printed thereon for additional esthetic features.

A preferred embodiment of the present invention appears in its environment as shown in FIG. 1 in the form of a cylindrical bucket as at 10. The invention 10 suspends from a pole embedded in a ground surface as at S near a trailer T parked upon the ground surface S. Alternatively, the invention 10 may be placed directly upon the ground surface C.

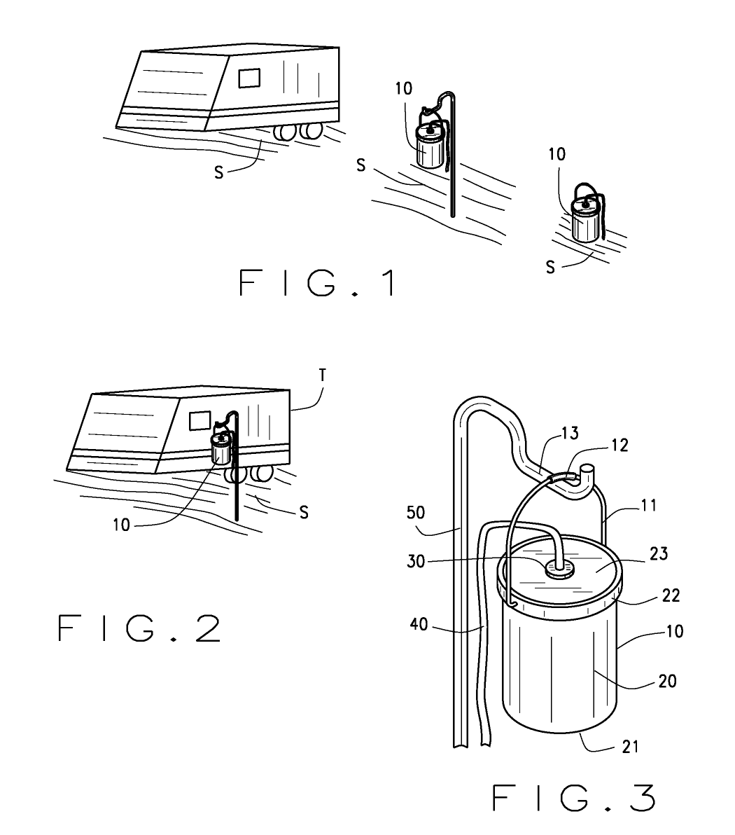

Turning to FIG. 2, it shows a perspective view of the invention 10 deployed proximate the trailer T upon the ground surface S.

FIG. 3 then shows the container 10 in a front view. The invention 10 has a bucket 20 generally cylindrical with a closed bottom 21 and an opposite open top. The top has a reinforced rim from a rib 22 upon its perimeter. The rib receives a lid 23 generally pressure fit thereon by a user. The lid has a planar shape with a reinforced edge that engages with the rib 22 of the bucket 20. Generally centered thereon, the lid has a socket 30 that delivers electrical power to a light source within the bucket, not shown. The socket has electrical communication to a cable 40 of a length suitable for campsite use, generally more than twelve feet.

From the rib 22, the invention 10 has a handle 11 generally of arcuate metal wire secured at two opposite points upon the rib. The handle extends upwardly as the bucket suspends beneath it. Centered upon the handle, it has a grip 12 and a S shaped hook 13 further extending outwardly from the handle. The S shaped hook rests upon a bight of a pole 50 embedded into the ground surface, not shown in this figure.

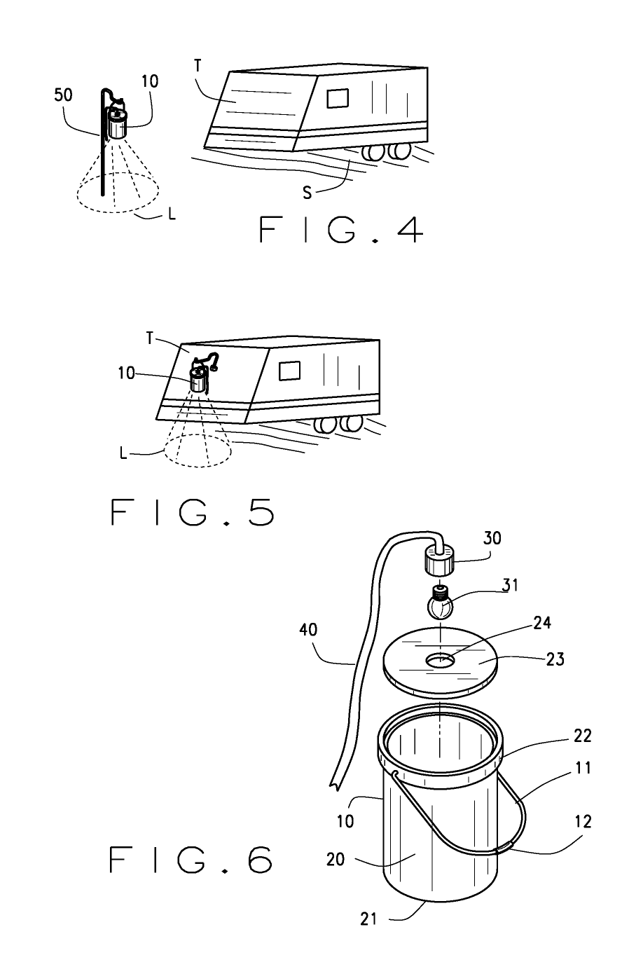

Rotating the outer tub, FIG. 4 shows a side view of the invention 10 deployed upon a pole 50 in the vicinity of the trailer T. The invention casts a light in a generally circular area centered beneath the invention 10, here shown as the area as at L. The invention generally has a translucent construction to support suitable light transmission.

FIG. 5 then describes the redneck pole light invention in a perspective view much like a user would see it when place near or upon a trailer T. The invention 10 casts it illumination upon the area L here shown as a truncated round area partially intersected by a corner of the trailer.

And, FIG. 6 provides an exploded view of the invention 10. The invention 10 has electrical power delivered through its cable 40 that terminates in its socket 30. The socket has a threaded or other connection to admit a light source 31, here shown as an incandescent bulb. However, the Applicants foresee additional forms of light as suitable for the invention, such as fluorescent and light emitting diode.

The light source fits into an aperture 24 centered upon the lid 23. The lid fits within the handle 11 extending from the rib 22. The rib as before extends around the perimeter of the open top of the bucket 20. Opposite the top and the rib, the bucket has its closed bottom 21. Upon assembling the invention, the light source has a waterproof connection through the lid and then emits light through the bucket upon delivery of electrical power to it. The bucket of the invention then illuminates an area beneath it.

The foregoing description of the preferred embodiment of the present invention has been presented for the purposes of illustrations and description. They are not intended to be exhaustive of to limit the present invention to the precise forms disclosed, and many modifications and variations may arise in light of the above teachings. The preferred embodiment was chosen and described to best explain the principles of the present invention and its practical application. The foregoing descriptions thereby suggest to other skilled in the art to best utilize the present invention and various embodiments with various modifications as are suited to the particular use contemplated by a user.

From the aforementioned description, a redneck pole light has been described. The redneck pole light is uniquely capable of compact internal storage of electrical cable when not in use and illuminating an area without attracting insects during its usage. The redneck pole light and its various components my be may be manufactured from many materials, including but not limited to, transparent polymers, steel, aluminum, opaque polymers, ferrous and non-ferrous metal foils, their alloys, and composites.

Various aspects of the illustrative embodiments have been described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations have been set forth in order to provide a thorough understanding of the illustrative embodiments. However, it will be apparent to one skilled in the art that the present invention may be practiced without the specific details. In other instances, well known features are omitted or simplified in order not to obscure the illustrative embodiments.

Various operations have been described as multiple discrete operations, in a manner that is most helpful in understanding the present invention, however, the order of description should not be construed as to imply that these operations are necessarily order dependent. In particular, these operations need not be performed in the order of presentation.

Moreover, in the specification and the following claims, the terms “first,” “second,” “third” and the like—when they appear—are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to ascertain the nature of the technical disclosure. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

I claim:

1. A portable illumination device, said device comprising:
a cylindrical bucket having a closed bottom and an opposite open top;
a lid operatively connecting to said top of said bucket;
a handle extending outwardly from said bucket proximate said lid;
a socket placed through said lid and having an electrical cable connected thereto;
a light source operatively connected to said socket wherein said light source illuminates interiorly of said bucket and said bucket casts light outwardly from it upon delivery of electrical power to said light source; and,
a hook extending outwardly from said handle.

2. The portable illumination device of claim 1 further comprising:
a rim upon said bucket proximate said top, said rim having said handle in operative connection thereto; and,
said rim having a configuration suitable for receiving said lid.

3. The portable illumination device of claim 2 further comprising:
said cylindrical bucket being translucent and waterproof; and,
said lid engaging said rim wherein said device prevents insects and water from entering therein.
